(19) United States
(12) Patent Application Publication
(10) Pub. No.: US 2006/0116474 A1
(43) Pub. Date: Jun. 1, 2006

(54) Compatibilized thermoplastic vulcanizate blends and their morphology as determined by atomic force microscopy

(76) Inventors: David A Jarus, Cleveland, OH (US); Marina A. Rogunova, Rocky River, OH (US); Ashok M. Adur, Westlake, OH (US)

Correspondence Address: John H Hornickel;PolyOne Corporation, 33587 Walker Road, Avon Lake, OH, 44012, US

(21) Appl. No.: 10/530,361

(22) PCT Filed: Oct. 2, 2003
(86) PCT No.: PCT/US03/31764

§ 371 Date: Apr. 4, 2005

Related U.S. Application Data
(60) Provisional application No. 60/416,658, filed on Oct. 7, 2002.

(51) Int. Cl. C08L 53/00

(52) U.S. Cl. 525/88

(57) ABSTRACT

Thermoplastic Vulcanizate (TPV) blends are disclosed wherein the otherwise generally compatible blend of thermo-plastic and crosslinked elastomer is made unexpectedly more compatible on the nano-scale, as evaluated Atomic Force Microscopy (AFM). The blends comprise a polyolefin matrix, domains of well-dispersed crosslinked olefinic rubber particles and the presence between the rubber particles of ligaments of a compatibilizing copolymer comprising olefin monomeric units and aromatic monomeric units. The addition of the compatibilizer increased the dispersion of olefinic rubber particles.

### CLAIM OF PRIORITY

This application claims priority from U.S. Provisional Patent Application Ser. No. 60/416,658 bearing Attorney Docket Number 1200211 and filed on Oct. 7, 2002.

### FIELD OF THE INVENTION

This invention relates to compatibilized thermoplastic vulcanizate blends and the use of atomic force microscopy to study the morphology of such thermoplastic vulcanizates.

### BACKGROUND OF THE INVENTION

In the past several decades, the use of polymers has transformed the world. Polymer science has rapidly evolved to make thousands of different thermoplastic and thermosetting products. This rapid progress in polymer science and engineering, and the growing impact of polymer technologies on industry, require optimized structure-property relationships in polymer blends.

In recent years, atomic force microscopy (AFM) has proven to be an invaluable tool for visualization of immiscible and miscible blends, as well as differentiation between partially miscible and highly compatible immiscible blends. Studies of such activities have been reported by Maier et al., J. Polym. Sci., Part B: Polym. Phys. 35, 1135, (1997); Galushka et al, Surf. Interface Anal. 25, 418, (1997), and Cabral, Macromolecules, 35, 1941, (2002).

The use of thermoplastic vulcanizates (TPV) is wide spread, as reported in Thermoplastic Elastomers, edited by Holden et al. (1996). A TPV has many of the properties of elastomers due to high elastomeric volume concentration. Because of a thermoplastic matrix, they are readily processable as a thermoplastic. See, e.g., O'Connor et al., Rubber World, December 1981-January 1982.

The effect of particle size on the mechanical properties has been clearly demonstrated, with smaller particles resulting in more ductile blends, as reported in Coran et al., Rubber Chem. Technol., 43, 141, (1980)

In general, polyolefins such as polypropylene (PP) and elastomers such as ethyl ene-propylene-diene rubber (EPDM) are compatible polymers and require no additional surface-active materials to achieve good blend properties. However, there is always room for increasing the dispersion and adhesion of two-phase systems to increase the mechanical properties.

### SUMMARY OF THE INVENTION

What the art needs are better blends of thermoplastic vulcanizates that can reduce production time and energy consumption to blend such thermoplastic vulcanizates, while also providing comparable or improved physical properties of such blends.

The art also needs a means of prediction of final chemical and physical properties of thermoplastic vulcanizate blends.

“Thermoplastic vulcanizate” or “TPV” means a blend, where a thermoplastic material represents a matrix and a rubber formed of fine dispersed particles. The rubber particles have been cross-linked to provide elasticity by the process of dynamic vulcanization during its melt mixing with a molten thermoplastic.

The present invention solves that problem by introducing compatibilizers into TPV blends, even for such blends that are otherwise generally have compatible thermoplastic and rubber materials. It is unexpected that a generally compatible TPV would require compatibilizer. However, the present invention provides reduced production time and energy consumption during manufacturing as a result of the addition of a minor amount of compatibilizer to a generally compatible system, such as PP/EPDM blends.

The present invention also solves the problem by investigating the efficiency of compatibilizer using Atomic Force Microscopy (AFM). AFM can elucidate the morphology development of the PP/EPDM blends with and without compatibilizer, can develop structure/processing/property relationships of such blends, and can demonstrate the usefulness of AFM as a prediction tool in developing structure/property/processing relationships of such compatibilized blends. While some studies have employed AFM to study a TPV blend, none has investigated the effect of a compatibilizer on a generally compatible TPV blend.

One aspect of the present invention is a thermoplastic vulcanizate compound, comprising a blend of (a) a polyolefin; (b) an olefinic rubber; and (c) a minor amount of a compatibilizer selected from the group consisting of styrenic block copolymers, alpha-olefin copolymers, a copolymer comprising olefin monomeric units and aromatic monomeric units, and combinations thereof.

“Generally compatible” means that the crosslinked rubber phase of the TPV has a good adhesion and finely dispersed in a continuous olefinic phase. The average rubber particle size can range from as small as physically possible to about 10 μm in diameter. Desirably, the particle size of the rubber particles can range from about 0.1 μm to about 5 μm in diameter, and preferably from about 0.3 μm to about 2 μm in diameter.

“Minor amount” means a minor weight percentage of copolymer, relative to the olefinic rubber. Desirably, the minor weight percentage ranges from about 0.5 to about 10, and preferably from about 1 to about 5.0. Expressed alternatively in parts per hundred parts of rubber (“phr”), the minor amount of copolymer ranges from about 0.5 to about 50 phr, and preferably from about 2.5 to about 25 phr, depending on the olefinic rubber selected.

The minor amount of the copolymer serves as a compatibilizer for the otherwise compatible TPV. Desirably, the copolymer is selected from the group consisting of olefinic and styrenic copolymers, such as ethylene styrene copolymers, ethylene alpha olefin copolymers, styrenic block copolymers, such styrene ethylene butylene styrene, ethylene acrylate copolymers, and ethylene vinyl acetate copolymers. The copolymers can be random, pseudorandom, or block in structure.

Another aspect of the present invention is a method of using AFM to determine morphology of compatibilized TPV blends and to predict physical properties therefrom, comprising the steps of: (a) preparing small scale batch blends of the TPV; (b) sampling the material as a function of time; (c) elucidating the morphology as a function of time; and (d) developing structure-property relationships from the elucidated structures.

A feature of the present invention is the thermoplastic compatibilizer diffuses in the molten state into the olefinic rubber domains in the blend, with subsequent crystallization upon cooling such that the compatibilizer links domains of crosslinked olefinic rubber particles dispersed in the polyolefin matrix.

Another feature of the present invention is that the particle size of crosslinked olefinic rubber particles in an otherwise generally compatible TPV blend is reduced even further by the presence of the compatibilizer chosen. When the TPV is a blend of PP and EPDM, the high compatibility of PP and EPDM would lead one skilled in the art to expect that no compatibilizer would be needed nor would the compatibilized PP/EPDM be any more efficient than such blends without any compatibilizer.

Another feature of the present invention is the use of nano-scale resolution of AFM to identify compatibilizer linkages between olefinic crosslinked rubber domains.

An advantage of the present invention is a reduction in hardness of the compatibilized blend compared with a non-compatibilized blend, along with equivalent or improved mechanical properties of Ultimate Tensile Strength and Elongation at Break. Also, such compatibilized blends of the present invention have improved Compression Set at 100° C. and 22 hours of testing. Moreover, one skilled in the art can achieve Shore A hardness levels with TPV blends of the present invention that permit usage in very “soft touch” elastomeric products, such as hand grips, gaskets, and weather seals or other products where the Shore A hardness of the TPV is as low as about 40.

Another advantage of the present invention is using AFM to provide a visualization of the morphology development during mixing at regular intervals to allow a prediction of mechanical and impact properties as well as the optimization of the process parameters.

Another advantage of the present invention with the use of compatibilizers in PP/EPDM blends is faster residence time before introduction of curatives, increasing manufacturing efficiency and reducing energy consumption. Less complicated equipment or shorter reaction processors become possible. The overall throughput of the blend with a reduction in energy consumption more than make up for the increased cost of the otherwise generally compatible blend because of the addition of the minor amount of the compatibilizing copolymer, the “compatibilizer” described herein. Other features and advantages will become apparent when describing embodiments of the invention with respect to the following drawings.

### BRIEF DESCRIPTION OF THE DRAWINGS

FIG. 1(a) shows AFM phase images of EPDM/Compatibilizer system without oil.

FIG. 1(b) shows AFM phase images of EPDM/Compatibilizer system with oil.

FIG. 2 shows AFM phase images of PP/Compatibilizer system.

FIG. 3 shows DSC melting curves of PP (dashed line) and Compatibilizer (solid line).

FIG. 4(a) shows AFM phase images illustrating the comparative effect of the absence of Compatibilizer on the rate of dispersion in conventional PP/EPDM blends. Numbers indicate mixing time in minutes.

FIG. 4(b) shows AFM phase images illustrating the effect of the presence of Compatibilizer on the rate of dispersion in PP/Compatibilizer/EPDM blends of the present invention. Numbers indicate mixing time in minutes.

FIG. 5(a) shows Pre-cure morphology of conventional PP/EPDM blends.

FIG. 5(b) shows Pre-cure morphology of PP/Compatibilizer/EPDM of the present invention.

FIG. 6(a) shows Post-cure morphology of conventional PP/EPDM blends.

FIG. 6(a) shows Post-cure morphology of conventional PP/Compatibilizer/EPDM blends of the present invention.

FIG. 7 shows a three-dimensional topological profile of a PP/Compatibilizer/EPDM blend of the present invention.

FIG. 8(a) shows an AFM phase image of a conventional PP/EPDM blend.

FIG. 8(b) shows an AFM phase image of a PP/Compatibilizer/EPDM blend of the present invention.

FIG. 9 depicts a schematic illustrated morphology of PP/Compatibilizer/EPDM blend of the present invention.

FIG. 10(a) shows an AFM phase image of a conventional PP/EPDM blend sampled from a continuous process.

FIG. 10(b) shows an AFM phase image of a PP/Compatibilizer/EPDM blend of the present invention sampled from a continuous process.

### EMBODIMENTS OF THE INVENTION

Polyolefin

Polyolefin is a fundamental building block in polymer science and engineering because of the low cost, high volume production based on petrochemical production

Non-limiting examples of polyolefins useful in TPV blends include homopolymers and copolymers of polyethylene, polybutylene, and polypropylene (PP), the homopolymer of the last of which is preferred.

Polypropylene has thermoplastic properties best explained by a recitation of the following mechanical and physical properties: a rigid semicrystalline polymer of with a modulus of 1 GPa, a yield stress of 35 MPa, an elongation to ranging from 10 to 1000%.

Selection of a polyolefin from commercial producers uses Melt Flow Index properties. The Melt Flow Index can range from about 0.05 to about 1400, and preferably from about 0.5 to about 70 g/10 min at 230° C. under a 2.16 kg load. For PP, that Melt Flow Index should be from about 0.5 to about 70 and preferably from about 1 to about 35 g/10 min at 230° C. under a 2.16 kg load.

Non-limiting examples of PP useful for the present invention are those commercially available from multinational suppliers such as Dow Chemical, Basell Polyolefins, and BP Amoco.

Olefinic Rubber

Nonlimiting examples of olefinic rubbers are identified above. They are especially useful in TPV because their reasonable cost for properties desired. Of these rubbers, EPDM is preferred because it is a fundamental building block in polymer science and engineering due to its low cost, high volume, commodity synthetic rubber also based on petrochemical production.

The thermosetting properties of EPDM are best explained by the following mechanical and physical properties: low compression set, the ability to be oil extended to a broad range of hardness, and good thermal stability.

Selection of an olefinic rubber from commercial producers uses Mooney Viscosity properties. The Mooney Viscosity for olefinic rubbers can range from about 10 to about 200, and preferably from about 20 to about 100 ML 1+4 @100° C. For EPDM, that Mooney Viscosity should be from about 20 to about 100, and preferably from about 40 when the rubber is oil extended.

Non-limiting examples of EPDM useful for the present invention are those commercially available from multinational companies such as Bayer, Dupont Dow Elastomers, Uniroyal Chemical, ExxonMobil, and others.

A vulcanizing agent needs to be added to a well-mixed blend of EPDM rubber and thermoplastic PP during mixing. Dynamic vulcanization of olefinic rubber occurs while mixing continues. Curatives such as brominated phenolics and non brominated phenolics in the presence of a catalyst (commercially available from Schenectady International, Inc. of Schenectady, N.Y.) are included in the blend after mixing in an amount ranging from about 1 to about 8, and preferably from about 2 to about 5 phr. Alternative crosslinking agents can be organic peroxides, such as dicumyl peroxide or amyl peroxide commercially available from Atofina Chemicals and Akzo Nobel.

TPV Blends of PP and EPDM

Bringing together the attributes of PP as a thermoplastic and EPDM as an olefinic rubber is very desirable in the art because of the excellent elastomeric properties of crosslinked EPDM rubber domains dispersed in semicrystalline PP, which itself has good mechanical and chemical resistance. As such, there are many commercial blends of PP/EPDM TPV blends where the amount of EPDM is adjusted to provide hardness and elastomeric control to the blend. However, in these commercial blends, a compatibilizer is not needed to enhance the compatibility of PP and EPDM. The present invention has found the value of including a compatibilizing copolymer unexpectedly changes the morphology of the TPV for production and performance benefits.

Because commercial uses of PP/EPDM TPV blends are determined by end use properties desired, an expression of relative participation of these constituents in the blends should not be viewed as limiting to one skilled in the art. Without undue experimentation, one skilled in the art can vary the constituent concentrations of blends of the present invention to achieve a desire Shore A hardness or a level of elastomeric control (such as compression set) not previously possible, because of the unique morphology generated by the addition of a compatibilizer copolymer to an otherwise generally compatible TPV blend.

For the preferred TPV blend, concentration of the constituents of the blend can range in a ratio of PP:EPDM from about 1:4 to about 2:1, and preferably from about 1:3 to about 1:1. In stating these ranges, the amount of optional oil (to be discussed later) has not been considered.

Compatibilizer

A thermoplastic compatibilizer for the rubber phase in a TPV is useful in the present invention because of the decreased time for dispersion of the rubber as well as the decrease in particle size of the EPDM domains, all while maintaining equivalent or better mechanical properties at a lower Shore A hardness.

Non-limiting examples of compatibilizers include styrenic block copolymers, such as styrene-butadiene-styrene and styrene-ethylene-butylene-styrene, copolymers of alpha-olefins, such as ethylene-octene, ethylene-butene, ethylene-propylene, and copolymers comprising olefin monomeric units and aromatic units (e.g., alpha-olefins with styrenics such as ethylene-styrene copolymers), and combinations thereof. The compatiblizers can be block copolymers, random copolymers, or pseudorandom copolymers.

Concentration of compatibilizer in the PP/EPDM blend has been identified above in the definition of minor amount.

Optional Oil

Oil extended olefinic rubbers are also useful in the present invention. Oil extension is well known in the art. Oil can be a separate ingredient in the blend or can be a part of the olefinic rubber, depending on commercial source of supply. In TPV blends, it is often desirable to include an oil to extend the rubber portion of the blend. This oil extension provides the properties of lower hardness and better compression set while reducing cost of the rubber to achieve the same volume.

Non-limiting examples of oils suitable for optional use in the present invention include paraffinic mineral oil and napthathenic mineral oils.

Concentration of oil in the PP/Compatibilizer/EPDM blend can range from about 0 to about 200 phr, and preferably from about 0 to about 100 phr.

Preparation of Blends

Blends can be made on a batch basis or a continuous basis. Economies of scale for production seek a continuous mixing and blending process.

For batch production, the TPV samples can be made on a mixing head, typically a Brabender-type mixing head. All resins can be charged into the mixing head at a temperature ranging from about 170 to about 210° C., and preferably from about 175 to about 185° C. Mixing proceeds at a pace ranging from about 10 to about 100 rpm (revolutions per minute), and preferably from about 75 to about 85 rpm for a duration ranging from about 1 to about 5 minutes, and preferably from about 2 to about 4 minutes. Thereafter, a suitable amount of curative is added, ranging from about 1 to about 8 phr, and preferably from about 2 to about 5 phr. The mixture is then allowed to mix for an additional period of time, ranging from about 1 to about 10, and preferably from about 6 to about 8 minutes to permit dynamic vulcanization of the olefinic rubber domains. For kinetic analysis, small samples can be]then removed from the mixture at intervals ranging from about 30 to about 60 seconds, and preferably from about 25 to about 35 seconds. Plugs of the cured blend were then removed and compression molded into a 7.6×15.2×0.31 cm (3×6×0.125 inch) plaque mold at a temperature ranging from about 170° C. to about 210° C., and preferably from about 175 to about 185° C. The plug material is held under no pressure for 30 seconds and then the pressure was increased to 1100 kN force over a period of about 3 minutes. Pressure of 1100 kN force was applied for 4 minutes, and then the samples were cooled while maintaining pressure.

Continuous production of TPV blends is preferred and can use any of the equipment and processes known to those skilled in the art. The addition of the minor amount of the compatibilizing copolymer according to the present invention should not alter the preferred means of malting the TPV blend into which the compatibilizing copolymer is to be added.

A wide variety of reactive extrusion equipment can be employed. Preferred is a twin screw corotating extruder with an L/D ratio ranging from about 38 to about 60, and preferably from about 40 to about 52.

The profile for the preferred PP/EPDM reactive extrusion can be a flat 190° C. profile and 500 rpm. The material can be fed at 27 kg/hr (60 lbs/hr) on a 25 mm twin screw extruder.

To obtain samples for kinetic analysis, after the extruder reached steady state conditions, the barrels can be set to 60° C. and water cooling can be used to cool the barrel down to 105° C. Then the water cooling can be turned off. The barrels can be then subsequently set at 180° C. and the screws can be pulled out when the barrels reached 150° C.

### USEFULNESS OF THE INVENTION

Once compatibilized and evaluated with AFM according the methods of the present invention, TPV blends, especially of PP and EPDM, have great utility in polymer science. Such compatibilized blends exhibit increased mechanical properties at lower hardness values. In commercial usage, such properties can translate into softer compounds having equivalent mechanical properties to harder compounds, which is unexpected because, in general, decreasing the hardness of a TPV also reduces its mechanical properties.

PolyOne Corporation (www.polyone.com) sells TPV blends into the automotive, consumer and industrial markets. Customers of PolyOne Corporation use TPV blends for a wider variety of products, including without limitation, handgrips, seals, gaskets, gearshift boots, housing and “soft touch” applications. Commercial usage requires production molding such as injection molding techniques, extrusion molding techniques, and blow molding techniques known to those skilled in the art of polymer science and engineering.

Further embodiments of the invention are described in the following Examples.

### EXAMPLES

Materials

All TPVs were made with a constant weight fraction of paraffinic mineral oil included to target a specific hardness and EPDM, both 37.5 wt %. The level of PP was either 25 wt % for the non-compatibilized system, or 20 wt % PP for the compatibilized system and 5 wt % of a thermoplastic compatibilizer. No molecular variables of the EPDM, oil, or PP were introduced; the only change in parameters was the addition of a minor amount of a compatibilizing copolymer according to the present invention. The chosen ingredients were pariffinic mineral oil; polypropylene homopolymer having a Melt Flow Index of 12 from Basell; EPDM being Buna KA 8537 from Bayer, and compatibilizing copolymer: ethylene styrene interpolymer DE201 from Dow Chemical.

### Comparative Blend Preparation—Comparative Examples A-C

In an effort to determine the suitability of the compatibilizer with the EPDM and the PP, blends were first prepared at a 20/80 ratio, EPDM/compatibilizer, or PP/compatibilizer respectively. Each blend was charged to a Brabender mixing head at 80 RPM, 180° C. and mixed for 5 minutes. The plug was then removed and allowed to air cool. An additional 20/80 EPDM/compatibilizer with 20 phr additional oil blend was prepared under the same conditions to determine the effect of oil on compatibility.

### TPV Blend Preparation—Example 1

The TPV samples were also made on the Brabender mixing head. All resins were again charged at 180° C., 80 rpm and mixed for 3 minutes. After 3 minutes, a suitable amount of brominated phenolic curative was added and the mixture was allowed to mix for an addition 7 minutes. Small samples were removed from the mixture at 30 second intervals. The remaining plugs were then removed and compression molded at 180° C. The material was held under no pressure for 30 seconds and then the pressure was increased to 1100 kN force over a period of 3 minutes. Pressure of 1100 kN force was applied for 4 minutes, and then the samples were cooled while maintaining pressure.

Techniques

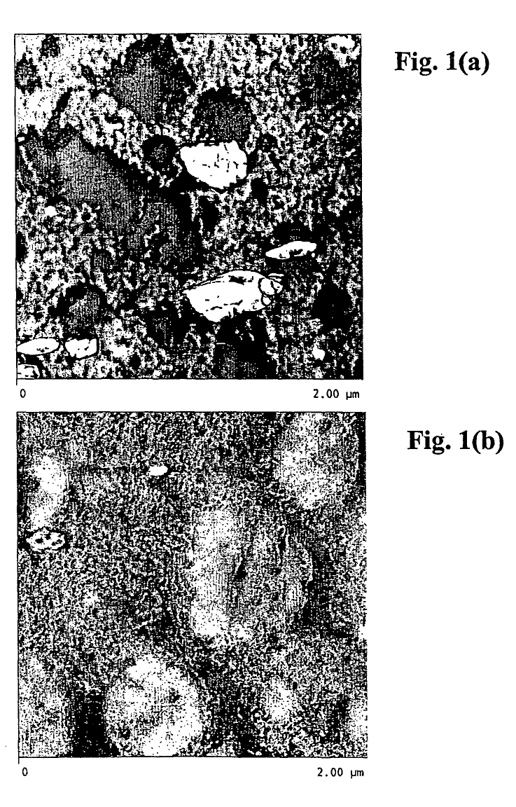

Atomic Force Microscopy (AFM).—To study the morphology of the blends, the cross-sections were microtomed perpendicular to the surface of the plaques and observed directly. The AFM images were obtained in air with a commercial scanning probe microscope Nanoscope IIIa (Digital Instruments, Santa Barbara, Calif.) operating in the tapping mode. Measurements were performed at ambient conditions using rectangular type Si probes with a spring constant of 50 N/m⁻¹ and resonance frequencies in the 284-362 kHz range. The tip radius was 10 nm. The AFM topographic (height) and the elastic (phase) images were simultaneously obtained under normal and hard tapping conditions on the microtomed surface of blends. Phase images revealed hard regions in bright (thermoplastic phase) and soft regions in dark (rubber phase), except for FIG. 1(b) where that contrast was reversed.

Differential Scanning Calorimetry (DSC).—A TA Instruments model DSC 2920 was used to measure the melting behavior of the compatibilizer relative to the PP. The temperature was scanned from −120° to 260° C. at heating/cooling rates of 10° C./minute. A nitrogen gas purge of 50 mil/minute was used. Second heats are reported.

Pliysicalproperties.—Specimens were die cut from the compression molded plaques and subsequently tested for room temperature compression set (22 hrs), tensile properties, and hardness. ASTM D3954-00, D638-00-Type 4, D2240-00 were followed, respectively.

### RESULTS & DISCUSSION

### EPDM/Compatibilizer Systems—Comparative Example A

To confirm that the compatibilizer had a very strong affinity for EPDM materials, blends were made solely of virgin EPDM and compatibilizer. Atomic Force Microscopy (AFM) was used to determine the interaction, if any, between the materials. The image in FIG. 1(a) is composed of a continuous, compatibilizer phase, (bright) and the dispersed EPDM (dark). The white regions represent a very hard component, most likely talc that has been dusted onto the rubber to prevent blocking of the rubber after grinding. The rubber particle size was measured and ranged from 0.09 to 1 μm. In all cases, the EPDM was dispersed below the micrometer scale, indicating a very strong affinity between the two phases. For comparison, intensive mixing is required to achieve completely sub-micrometer phase domains of EPDM in either polyethylene or polypropylene even with the optimum E/P ratio of the EPDM.

In addition, the rough phase boundaries observed on the rubber particles and small lamella protruding into rubber phase indicated diffusion of compatibilizer into the rubber phase. This can be seen in the image of FIG. 1(a) by the protruding lamellae of compatibilizer into the EPDM domains. The result of this diffusion is an anchoring of the compatibilizer phase in EPDM after subsequent crystallization upon cooling from the melt. The increased adhesion between the phases should allow for greater stress transfer and consequently a higher tensile strength of the material.

Suitable plasticizers can be added to TPV systems and may act as both processing aid in the melt and also as a softener at the low temperature of use. The effect of mineral oil on the systems was also investigated. The AFM image in FIG. 1(b) depicts the continuous compatibilizer phase and the dispersed, oil impregnated EPDM phase. The EPDM phase size is larger than in FIG. 1(a), ranging from 0.3 to 1 μm. However there is still evidence of compatibilizer diffusion into the rubber phase, as evidenced by darker lamellae piercing the rubber phase. The larger EPDM phase size was due to the addition of oil to the material, causing the rubber phase to swell.

### PP/Compatibilizer System—Comparative Example B

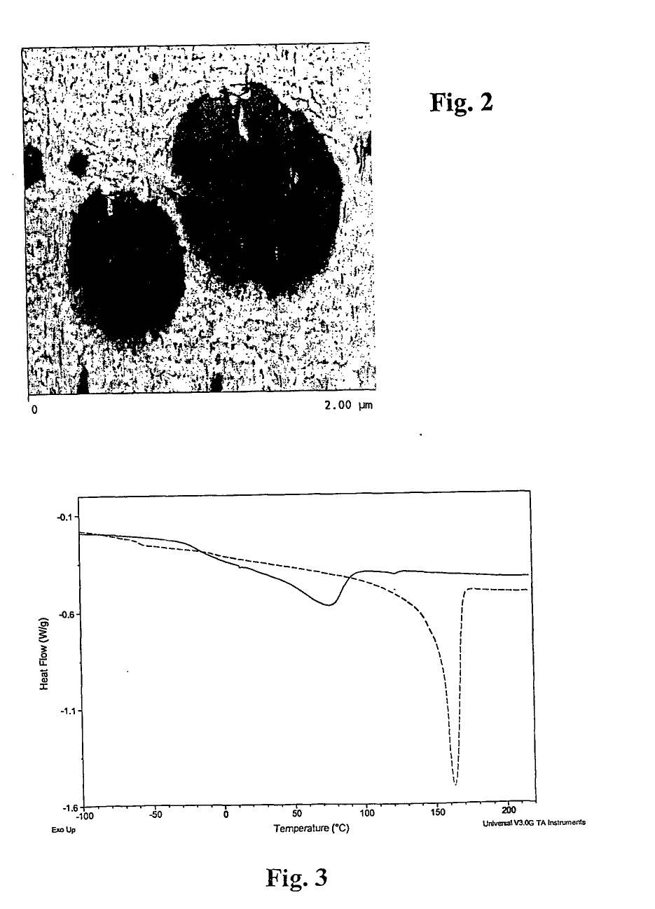

The image in FIG. 2 is composed of a continuous, PP phase, (bright) and the dispersed phase is the compatibilizer (dark). The size of compatibilizer domains ranged from 0.2 to 1 μm, indicating a very strong affinity between the two phases. Similar to the EPDM/compatibilizer system, the rough phase boundaries on the dispersed particles and small protruding lamellae of PP into the compatibilizer domains were predicted to result in increased adhesion between the phases. These quick microscopy measurements were found suitable to warrant the use of this compatibilizer for a PP/EPDM system.

### TPV—Example 1

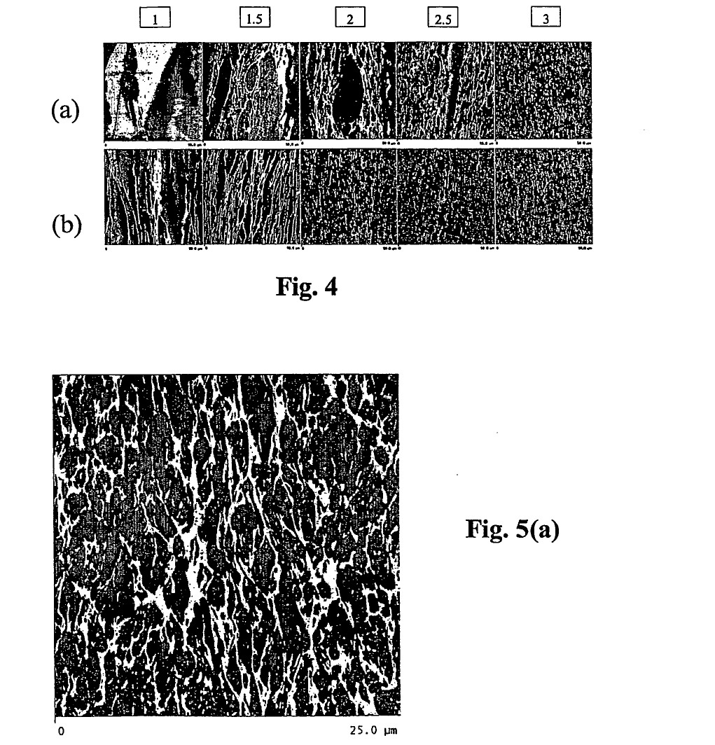

Macroscopic Morphology Development.—The addition of small amounts of compatibilizer was seen to have several effects on the production of TPVs. First, as indicated by DSC data (FIG. 3) the compatibilizer melts at a much lower temperature than PP, and therefore the dispersion of the EPDM occurred quicker in the barrelzone. Secondly, the compatibilizing effect further increased the efficiency of the dispersion process for both particle size and kinetics. Faster dispersion of the material allowed for earlier introduction of the curative into the system. This should relate to more productive use of continuous processing equipment and a savings of energy. To determine the effect of compatibilizer on the development of the morphology, samples were taken at 30 second intervals out of the mixing head bowl in the batch process and analyzed by AFM to determine the level of dispersion. This small scale mixing head experiment allows for greater resolution clearly delineating the effect of the compatibilizer over a broader time scale. Phase images are shown in FIG. 4, at thirty second intervals, with the dark phase constituting the EPDM phase. A TPV blend without compatibilizer was prepared for comparison, becoming Comparative Example D. As seen in FIG. 4(a), after 1.5 min the EPDM phase (without compatibilizer) formed large elongated domains on the scale of tens of microns (30-45 μm). After two minutes the micro-domains of EPDM greater than 25 μm were still present in the blend. In contrast as seen in FIG. 4(b), after 1.5 minutes the domain size of the EPDM in the presence of the compatibilizer were smaller; most of the domains were on the scale of 7-10 μm. Only a couple of domains were more than 25 μm in size. After two minutes, the compatibilized blend resulted in relatively homogenous rubber domains on the scale of 5 μm.

Consequently, a curing agent can be added earlier in the process validating the use of a compatibilizer. This is an unexpected advantage of the invention, reducing production time and saving energy.

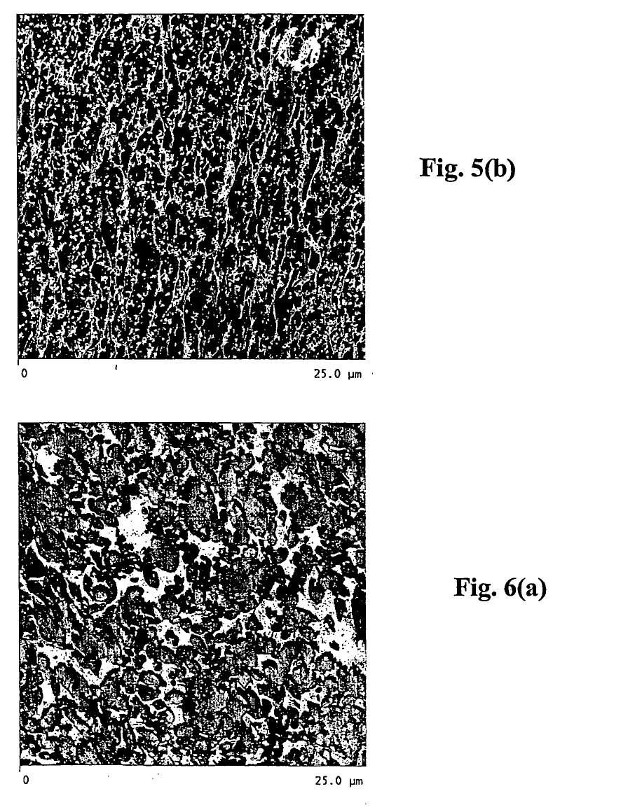

Microscopic pre-cure morphology.—FIGS. 5(a) and 5(b) compare the microscopic pre-cure morphology of both non-compatibilized and compatibilized blends, respectively. Three minutes of mixing time was chosen for comparison, just prior to curative addition. In the non-compatibilized system, as seen in FIG. 5(a), EPDM formed elongated domains dispersed in the PP matrix. The existence of a dispersed EPDM phase at this high volume fraction of the EPDM/oil phase was surprising, with little co-continuous structure evident. The size of EPDM domains varied from 1 to 4 μm. The individual EPDM domains were separated by relatively thick ligaments of the PP matrix is some areas, however particle to particle contact of the EPDM was also prevalent. As seen in FIG. 5(b), the introduction of compatibilizer resulted in less distinct individual EPDM domains, and more evidence of a co-continuous structure. The matrix ligaments separating the EPDM phase were additionally thinner and more uniform. Additional hard phase nano scale domains also existed inside the EPDM phase, nonexistent in the non-compatibilized system. The presence and location of the compatibilizer will be discussed in a subsequent section of the Examples.

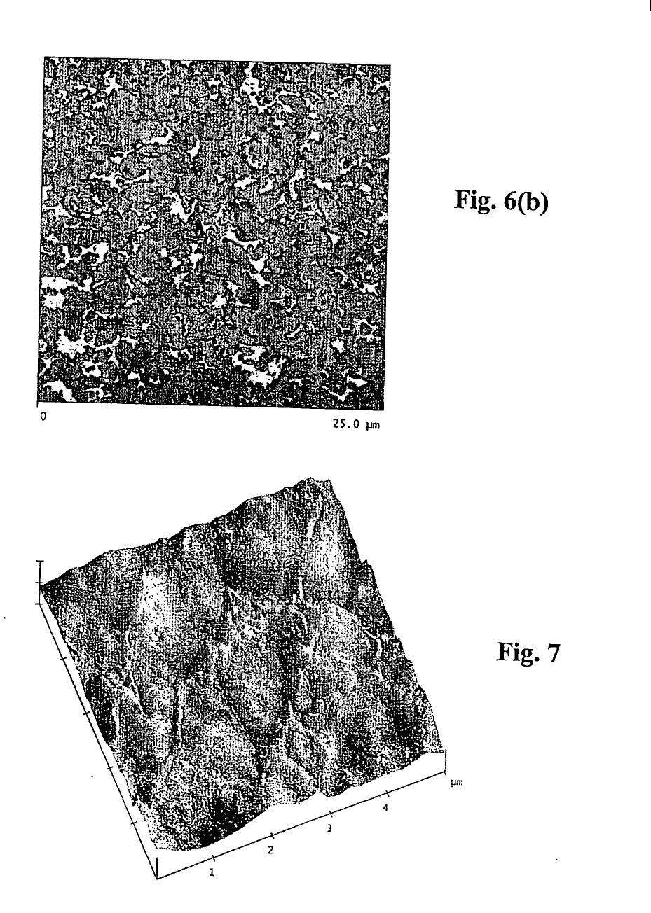

Micro post-cure morphology.—The dispersion of the EPDM is shown in FIGS. 6(a) and 6(b) after curative addition without and with the compatibilizer, respectively. Six minutes of mixing time is depicted, 3 minutes after curative addition. FIG. 6(a) shows the EPDM phase was clearly dispersed in the PP matrix on the micrometer scale, even without the compatibilizer. Particle sizes of the EPDM range from 0.7 to 3 μm. With the compatibilizer, FIG. 6(b) shows what at first examination appear to be larger domains of EPDM, possibly aggregates of smaller EPDM phase domains. This result was unexpected, because the EPDM phase should be smaller assuming the validity in choice of compatibilizers. The EPDM domains were investigated further at a smaller scale to discern the possible presence of aggregates.

Nano-morphology.—The appearance of EPDM domains larger than 2 μm was disconcerting, and higher magnifications were used to discern the true EPDM dispersed morphology. Unexpectedly as a result of the use of AFM, what appeared to be large scale rubber domains was in fact aggregates of several EPDM domains separated by thin nano-ligaments of compatibilizer. This result was revealed most clearly in a three-dimensional topological AFM image, as seen in FIG. 7. This topographical image was an alternative display of the AFM apparatus.

It became apparent that the EPDM domains were in reality much smaller in the compatibilized system. However, determining the difference is only possible at high magnification, due to the size scale of the separating ligaments, about 50 nm. The resolution of the images should have revealed these ligaments on the micro scale, if the ligaments were completely composed of hard PP domains. However, as shown previously, the compatibilizer has a strong affinity for EPDM, with a large degree of interpenetrating chains. The blurring of the EPDM interface was caused by the compatibilizer phase interpenetrating different rubber particles. The diffusion of the compatibilizer into the EPDM results in an aggregate of EPDM domains that are physically networked by the compatibilizer. Only the use of AFM was able to determine the true morphology of the TPV blend.

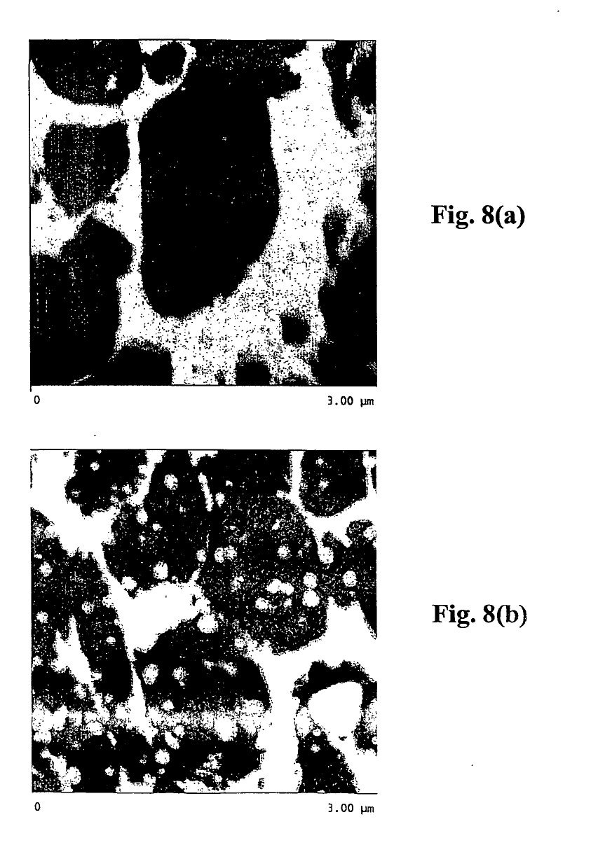

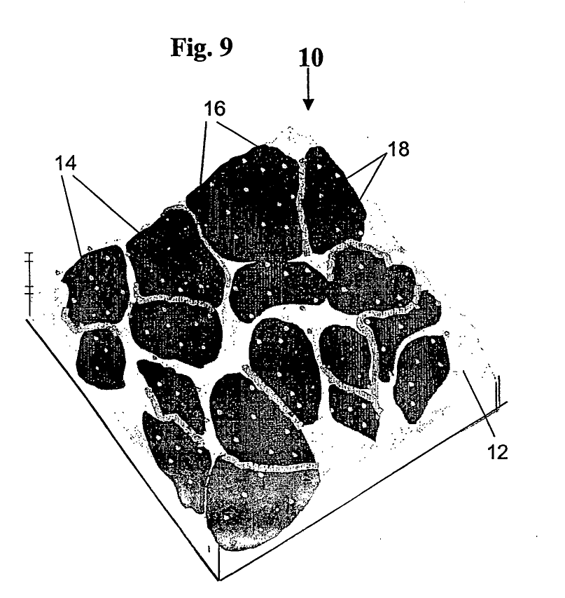

The evidence of the compatibilizer location is shown in a comparison of FIG. 8(a) with FIG. 8(b). Clearly, FIG. 8(b) shows numerous “harder” domains dispersed in the rubber phase, being a factor of the presence of the compatibilizer. However, there are many of these domains that span the EPDM particles, as well as coat the EPDM particles in the form of ligaments, confirmed by that seen in FIG. 7. A schematic cartoon is drawn as FIG. 9 to depict the locations of the compatibilizer.

FIG. 9 shows the TPV blend 10, having a polyolefin continuous phase 12, in which olefinic crosslinked rubber particles 14 reside. Between adjacent particles 14 reside ligaments 16 of compatibilizing copolymer to provide greater dispersion than would otherwise be possible without such copolymer. Within rubber particles 14 are domains 18 of compatibilizing copolymer. The unique morphology created by adding a minor amount of compatibilizing copolymer to an otherwise generally compatible TPV blend is unexpected as explained above and only capable of determination by the use of AFM.

Without being limited to a particular theory, it is proposed that the presence and location of the compatibilizer should have several strong effects on the properties of the materials. First, one would expect better bonding of the EPDM to the PP phase, resulting in higher tensile strength. Second, due to the crystalline nature of the compatibilizer, one would expect greater connectivity of the EPDM phases. This is accomplished via a physical network structure of the compatibilizer phase spanning the EPDM particles, with crystallite domains in each. Greater connectivity should result in a more networked structure, and therefore higher elastic response. The presence of the greater adhesion should also manifest in lower compression set values with more “snap back” of the PP phase after deformation, which should translate to lower compression set values. In addition, the presence of smaller EPDM domains will result in greater elongation to break, as discussed previously. Lastly, the intermediate hardness of the compatibilizer relative to the PP and EPDM should lower the hardness of the sample. The reduction in PP concentration to accommodate the addition of the compatibilizer (while maintaining the overall level of thermoplastic) will also lower hardness.

Physical Properties.—In order to test the proposition of the theory articulated above concerning the interaction of the processing/structure/property relationships of blends of the present invention, each of the typical physical attributes were tested for conventional, non-compatibilized blends and compatibilized blends of the present invention. The same materials at the same concentrations of mixing as used in the above examples (Comparative Example D and Example 1) were tested. First, the hardness of the samples was determined to yield a baseline for comparison, as one would expect several property trends by changing the hardness alone, without the introduction of a compatibilizer. The addition of the compatibilizer does significantly affect the hardness, lowering the Shore A value (15 sec relaxation) from 72 to 64, a considerable drop in value. This translates into a difference of two property grades in the commercial marketplace, a significance for users of TPV blends.

Physical properties are listed in Table I.

TABLE I
Physical Property Measurements

| | No Compatibilizer | Compatibilizer |
|---|---|---|
| Test | (Comparative Example D) | (Example 1) |
| Hardness, Shore A, | 72 | 64 |
| 15 sec | | |
| Ultimate Tensile | 5.47 ± 0.62 | 5.42 ± 0.56 |
| Strength, MPa | | |
| Elongation to Break, % | 307 ± 35 | 335 ± 10 |
| Compression Set | 31 ± 2 | 22 ± 2 |
| at 100° C., 22 hr | | |

One skilled in the art would expect a decrease in compression set due to the lower hardness of the sample alone. However, to maximize the differences between the samples, compression set was measured at 100° C., well above the melting point of the compatibilizer. Compression values were lower by 9 percent because of the introduction of the compatibilizer, namely from 31 to 22%. It is difficult to distinguish the relative contributions of the compatibilizer and the lower hardness. However, even a 22 percent reduction unexpectedly provides a large improvement in compression set values when the samples only differ in hardness by 8 Shore points.

The compatibilizer showed little or no effect on Ultimate tensile strength (UTS). However, when one considers that the hardness is 8 Shore A points lower with compatibilizer, maintaining equal tensile strength at significantly lower hardness is strong evidence of the anchoring and bonding effects of the compatibilizer, in addition to the generation of a smaller particle size. Also, it can be seen that the addition of compatibilizer increases the elongation by about 30 percent. While not a relatively large change, it still is a notable increase.

This combination of properties in addition to unexpected shorter process times result in easier production of TPV's with enhanced properties.

Thus, AFM is an excellent tool for examining the morphological structure of TPVs from the macro to the micro scale. Structure/property/processing relationships have been illustrated to explain the effect of compatibilizer on producing TPVs with equivalent or improved mechanical properties at lower hardness, utilizing shorter mixing times. Thus, introduction of compatibilizers into blends of the present invention not only improves blend properties but also improves manufacturing efficiency and energy consumption.

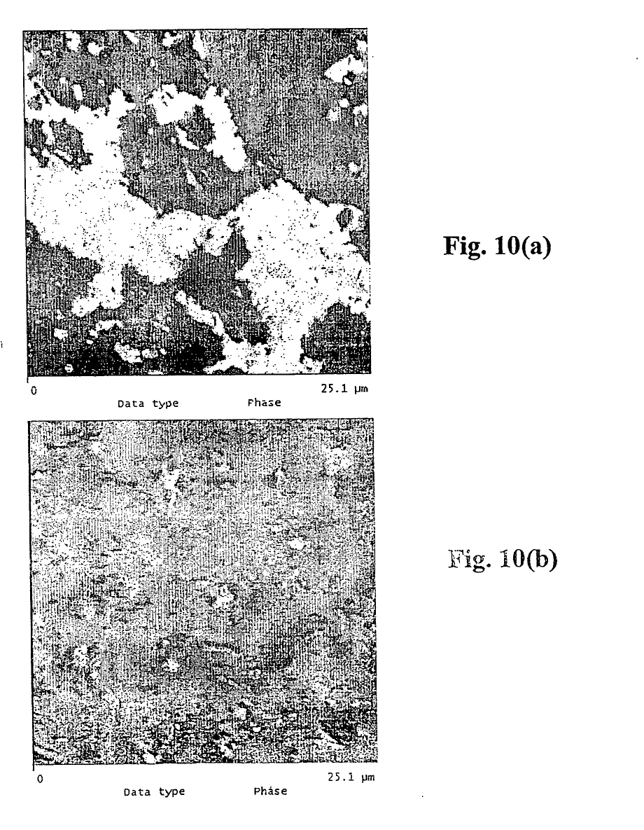

Continuous Processing—Comparative Example E and Example 2 To validate the small scale batch process Examples above, a continuous process was used to prepare TPV blends. The blends were made on a 25 mm Werner and Pfleiderer twin screw corotating extruder with an L/D ratio of 44. The blends were fed to the extruder and processed using the following conditions: a flat 190° C. profile and 500 rpm. The material was fed at 27 kg/hr. After the extruder reached steady state conditions, the barrels were set to 60° C. and water cooling was used to cool the barrel down to 105° C. Then the water cooling was turned off. The barrels were then subsequently set at 180° C. and the screws were pulled out when the barrels reached 150° C. Samples of materials at the third barrel section (12 L/D) were then analyzed by AFM morphology to determine if a difference dispersion rate occurred for the compatibilized system relative to the uncompatibilized system. These micrographs are shown in FIG. 10(a) without compatibilizer (Comparative Example E) and FIG. 10(b) with compatibilizer (Example 2).

Clearly, the compatibilized system seen in FIG. 10(b) reaches dispersion at the third barrel section of the extruder, whereas the uncompatibilized system seen in FIG. 10(a) does not It is apparent that the curative can be added at this point for the compatibilized system only, resulting in longer cure times and more efficient use of the length of the extruder. This translates to better productivity utilizing more conventional length extruders while improving physical properties. Alternatively, the process is completed more quickly, reducing energy consumption.

### Examples of Other Compatibilizers

Other compatibilizers were studied. These Examples were prepared using Buna KA 8902 (Bayer) as the EPDM and were run on a Brabender conical twin screw extruder, which was set up with a temperature profile of 170-185-200-200° C. and 150° C. at the die. Ice water was used in the water bath to cool the strands before pelletizing. The screw speed and feed rate were adjusted to get 30 sec. residence time. At least 2.2 kg. of material for each example was collected after reaching steady state (about 2.5 min.). The dispersion was checked using Atomic Force Microscopy. Table 2 shows the formulations and results.

TABLE 2

| | Comp. Ex. F | Ex. 3 | Ex. 4 | Ex. 5 | Ex. 6 | Ex. 7 |
|---|---|---|---|---|---|---|
| EPDM (Bayer KA 8902) | 66.6% | 64% | 64% | 64% | 64% | 64% |
| PP (12-15 Melt Flow Index) | 33.3% | 32% | 32% | 32% | 32% | 32% |
| E-O (DuPont-Dow Engage 8407 or 8400) | 0% | 4% | 0% | 0% | 2% | 2% |
| ESI (Dow DE 200.01) | 0% | 0% | 4% | 0% | 2% | 0% |
| SEBS (Kraton's Kraton G 1652) | 0% | 0% | 0% | 4% | 0% | 2% |
| Largest Size of Particle | >50 μm | 35 μm | 25 μm | 40 μm | 35 μm | 45 μm |
| Hardness Shore A | 68 | 70 | 67 | 65 | 68 | 66 |

The morphology exhibited in AFM photomicrographs clearly showed that Examples 3-7 have improved dispersion with smaller average particles compared to Comparative Example F which does not.

The next Examples were run with Royalene 4594 from Uniroyal as the EPDM on a Brabender conical twin screw extruder under the same conditions as for Examples 3-7. Table 3 shows the formulations and results.

TABLE 3

| | Comp. Ex. G | Ex. 8 | Ex. 9 | Ex. 10 | Ex. 11 | Ex. 12 |
|---|---|---|---|---|---|---|
| EPDM (Uniroyal Royalene 4594) | 58.3% | 56% | 56% | 56% | 56% | 56% |
| PP (12-15 MFI) | 33.3% | 32% | 32% | 32% | 32% | 32% |
| Kaydol white mineral oil | 8.3% | 8% | 8% | 8% | 8% | 8% |
| E-O (Engage 8407) | 0% | 4% | 0% | 0% | 2% | 2% |
| ESI (DE 200.01) | 0% | 0% | 4% | 0% | 2% | 0% |
| SEBS (Kraton G 1652) | 0% | 0% | 0% | 4% | 0% | 2% |
| Largest Size of Particle | >10 μm | 10 μm | 5 μm | 4 μm | 4 μm | 7 μm |
| Hardness Shore A | 60 | 63 | 60 | 57 | 61 | 59 |

The morphology exhibited by AFM photomicrographs showed improvement in particle size for Examples 8-10 and even better improvement for Examples 11-12.

The next Examples were run with three Nordel MG grades, which differ only in terms of Mooney viscosity, as the EPDM on a Brabender conical twin screw extruder under the same conditions as for Examples 3-7. Table 4 shows the formulations and results.

TABLE 4

| | Comp. Ex. H | Ex. 13 | Ex. 14 | Comp. Ex. I | Ex. 15 | Ex. 16 | Comp. Ex. J | Ex. 17 | Ex. 18 |
|---|---|---|---|---|---|---|---|---|---|
| EPDM (DuPont Dow Nordel MG 47085) | 33% | 32% | 32% | 0% | 0% | 0% | 0% | 0% | 0% |
| EPDM (Nordel MG 47130) | 0% | 0% | 0% | 33% | 32% | 32% | 0% | 0% | 0% |
| EPDM (Nordel MG 47150) | 0% | 0% | 0% | 0% | 0% | 0% | 33% | 32% | 32% |
| PP (12-15 MFI) flake | 33% | 33% | 33% | 33% | 33% | 33% | 33% | 33% | 33% |
| Kaydol white mineral oil | 34% | 33% | 33% | 34% | 33% | 33% | 34% | 33% | 33% |
| ESI (DE 200.01) | 0% | 2% | 0% | 0% | 2% | 0% | 0% | 2% | 0% |
| SEBS (Kraton G 1652) | 0% | 0% | 2% | 0% | 0% | 2% | 0% | 0% | 2% |
| Largest Size of Particle | >10 μm | 6 μm | 9 μm | 20 μm | 10 μm | 10 μm | 25 μm | 15 μm | 20 μm |

In each instance, the Examples had a smaller largest particle size than the comparable Comparative Example.

Additional Examples were prepared in a co-rotating intermeshing twin screw extruder. A Werner & Pfleiderer ZSK-30 twin screw extruder with a 36 L/D was used, fitted with a Gala underwater pelletizer with the water maintained at or below 50° C. The temperature settings used were 148-162-177-190-199-182-177° C. and 160° C. at the die. The screw speed and feed rate were adjusted to get 30 sec. and 40 sec. residence time. At least 2.2 kg (5 lb) of material were collected after reaching steady state (2.5 min.). The dispersion was checked using Atomic Force Microscopy. Table 5 shows the compositions and results.

TABLE 5

| | Comp. Ex. K | Ex. 19 | Ex. 20 | Ex. 21 | Ex. 22 | Ex. 23 |
|---|---|---|---|---|---|---|
| EPDM (Royalene X4594) pelletized | 58.3% | 56% | 56% | 56% | 56% | 56% |
| PP (12-15 MFI) | 33.3% | 32% | 32% | 32% | 32% | 32% |
| Kaydol white mineral oil | 8.3% | 8% | 8% | 8% | 8% | 8% |
| E-O (Engage 8407 or 8400) | 0% | 0% | 2% | 2% | 0% | 2% |
| ESI (DE 200.01) | 0% | 4% | 2% | 0% | 0% | 0% |
| SEBS (Kraton G 1652) | 0% | 0% | 0% | 2% | 0% | 0% |
| Supersoft (Basell Hifax 7320) | 0% | 0% | 0% | 0% | 4% | 2% |
| Largest Size of Particle | >100 μm | 6 μm | 7 μm | 6 μm | 6 μm | 5 μm |
| Melt Flow Rate (g/10 min.) | >10 | 5.6 | 5.5 | 5.7 | 5.8 | 5.9 |
| 230° C. 2.16 kg (ASTM D1238) | | | | | | |

These results showed excellent improvement of dispersion as shown by largest size of particle—an order of magnitude difference for Examples 19-23 compared with Comparative Example K. Moreover, melt flow rate was halved.

The invention is not limited to the above embodiments. The claims follow.

What is claimed is:

1. A thermoplastic vulcanizate compound, comprising:
a blend of
(a) a continuous phase of a polyolefin;
(b) a dispersed phase of an olefinic rubber comprising EPDM;
(c) a minor amount of a compatibilizer selected from the group consisting of styrenic block copolymers, alpha-olefin copolymers, a copolymer comprising olefin monomeric units and aromatic monomeric units, and combinations thereof; and
(d) an oil.

2. The compound of claim 1, wherein the polyolefin is polypropylene (PP).

3. The compound of claim 2, wherein the ratio of PP:EPDM ranges from about 1:4 to about 2:1.

4. The compound of claim 1, wherein the minor amount of compatibilizer ranges from about 0.5 to about 10 weight percent of the compound.

5. The compound of claim 4, wherein the styrenic block copolymer comprises styrene-butadiene-styrene, styrene-ethylene-butylene-styrene, or combinations thereof.

6. The compound of claim 5, wherein the alpha-olefin copolymer comprises ethylene-octene copolymer, ethylene-butene copolymer, ethylene-propylene copolymer, or combinations thereof.

7. The compound of claim 1, wherein the oil is a mineral oil.

8. The compound of claim 1, wherein the olefinic rubber comprises particles dispersed in the polyolefin, and wherein the compatibilizer causes the largest size of particle to be smaller than the compound without the minor amount of the compatibilizer.

9. The compound of claim 1, wherein melt flow rate of the compound with the minor amount of the compatibilizer is lower than melt flow rate of the compound without the minor amount of the compatibilizer.

10. A method of using AFM to determine morphology of compatibilized blends of TPV and to predict physical properties therefrom, comprising the steps of:
(a) preparing small scale batch blends of the TPV;
(b) sampling the material as a function of time;
(c) elucidating the morphology as a function of time; and
(d) developing structure-property relationships from the elucidated structures.
